(19) United States
(12) Patent Application Publication
(10) Pub. No.: US 2010/0091510 A1
(43) Pub. Date: Apr. 15, 2010

(54) HEADLIGHT FOR A MOTOR VEHICLE

(75) Inventors: Roman Nyderle, Dresden (DE); Thomas Preussner, Dresden (DE); Torsten Kopte, Kreischa (DE); Volker Kirchhoff, Wehlen (DE); Sabine Dreihoefer, Warstein (DE); Ralf Rochotzki, Lippstadt (DE); Dieter Jestel, Castrop-Rauxel (DE); Matthias Kalwa, Lippstadt (DE); Klaus-Dieter Steinborn, Mueglitztal/OT Burkhardsw (DE); Michael Falz, Dresden (DE); Bernd Buecken, Dresden (DE); Barbara Gebhardt, Heidenau (DE)

Correspondence Address: GREENBLUM & BERNSTEIN, P.L.C., 1950 ROLAND CLARKE PLACE, RESTON, VA, 20191, US

(73) Assignee: FRAUNHOFER-GESELLSCHAFT ZUR FOERDERUNG DER ANGEWAN FORSCHUNG E.V., Muenchen (DE)

(21) Appl. No.: 12/597,846

(22) PCT Filed: Apr. 18, 2008
(86) PCT No.: PCT/EP08/03120

§ 371 Date: Oct. 27, 2009

(30) Foreign Application Priority Data
Apr. 27, 2007 (DE) 10 2007 019 995.5
Apr. 18, 2008 (DE) 10 2008 019 664.9

(51) Int. Cl. B60Q 1/04

(52) U.S. Cl. 362/507; 362/546

(57) ABSTRACT

The invention relates to a headlight for a motor vehicle with a sealing disk, which as a component of a housing seals an interior enclosed by the housing from the environment, wherein a layer system, comprising a lower layer, followed by a metal layer and an upper layer, is deposited on the side of the sealing disk directed towards the interior by means of a vacuum method, wherein the lower layer and/or the upper layer is deposited either as a nitride of the elements Al or Si or as an oxide or a mixed oxide of the elements Si, Ti Al, Zn, Sn, In, Nb, Zr, or Ta.

The invention relates to a headlight for a motor vehicle. For the purposes of the invention the term headlight covers all lighting devices of a motor vehicle for producing light or for producing optical signals for other road users, such as, for example, front headlights and back-up lights, fog lights, headlights of additional lighting, headlights for parking lights, braking light or flashing devices.

For many decades incandescent lamps or so-called halogen lamps were used as lamps for motor vehicle headlights. The thermal radiation thereof was sufficient thereby to melt ice on a headlight surface or to prevent a frost or dew deposit. Recently, however, these lamps are also increasingly being replaced in the field of motor vehicles by the use of LEDs, which have a lower power consumption. This lower power consumption is based not least on a lower thermal radiation of these components.

Although this lower thermal radiation is welcomed in terms of the energy balance of a headlight, this also results in new problems, however, such as for example with respect to iced-up headlights or the condensation water formation inside a headlight, which must be solved.

### PRIOR ART

A headlight for a motor vehicle is known from DE 197 24 098 A1, in which a heating device is embodied on the inside of the headlight glass. The heating device can be, for example, an electrically conducting metal layer, which produces heat when current flows through and in this manner ensures that, for example, the iced-up headlight glass can be thawed. One disadvantage of a solution of this type is that the transparency of a metal layer is only unsatisfactory and thus the light efficiency of a headlight of this type is very limited.

### OBJECT

The technical object of the invention is therefore to create a headlight for a motor vehicle and a method for the production thereof, by means of which the disadvantages of the prior art are overcome. In particular, the headlight sealing disk should have a high transmission in the visible light wave range and a deicing of the headlight sealing disk should also be possible when LEDs are used as lighting.

This technical object is attained with the objects with the features of claims 1 and 29. Further advantageous embodiments of the invention are revealed by the dependent claims.

A headlight for a motor vehicle according to the invention comprises a sealing disk, which as a component of a housing seals an interior enclosed by the housing from the environment, wherein a layer system, comprising a lower layer, followed by a metal layer and an upper layer is deposited on the side of the sealing disk directed towards the interior. The lower layer and/or the upper layer thereby comprises either a nitride of the elements Al or Si or an oxide of the elements Si, Ti Al, Zn, Sn, In, Nb, Zr, Ta or a mixed oxide of at least two of the aforementioned elements.

With known headlights, in which only a thin metal layer is applied to the inside of the sealing disk, the transmission is reduced compared to an uncoated sealing disk by about 40%. However, in the case of a headlight according to the invention, the lower and the upper layer, which have a lower light refraction index compared to the enclosed metal layer, cause a reduction in the transmission of light in the wavelength range of 500 to 700 nm compared to an uncoated sealing disk of a maximum of 20%. This reduction is often even less than 10%. The light efficiency of a headlight is substantially increased thereby.

The metal layer enclosed between the lower layer and the upper layer can be used as a heating element when it is flowed through by a current. In this manner a sealing disk can be deiced or a frost or dew deposit can be counteracted.

An embodiment in which the upper layer and/or lower layer is embodied as a nitride also includes those variants in which the layer has an oxygen content and thus is embodied as an oxynitride. The oxygen content can thereby in turn have a gradient in the layer thickness shape.

If the upper layer and/or the lower layer is deposited as an oxide or mixed oxide, this can also be doped with one or more of the elements Al, F, B, P, Ce, Sn, Zn or S.

For the lower and the upper layer, layer thicknesses of 20 nm to 70 nm are suitable for ensuring a high transmission of the layer system.

The sealing disk of a headlight according to the invention can be composed of glass or also of a transparent plastic, such as, for example, PC, PMMA or APEC, and have a thickness of approx. 0.5 to 5 mm.

Since the metal layer of the layer system also acts as a heating element, elements that conduct electric current well, such as Ag, Al, Cu, Au, Pd or Pt are suitable as layer formers. The metal layer, which preferably has a layer thickness of 5 nm to 20 nm, can thereby be embodied of only one of these elements or an alloy of these elements.

Also crucial for the heating power of a layer system is the sheet resistance thereof. In one embodiment the layer system has a sheet resistance R^{□} of 1 to 100Ω/□. Although it would be more favorable to try to achieve the highest possible sheet resistance in order to achieve a high heating power, since only an onboard power supply with 12 V is usually available with a motor vehicle, an aimed-for sheet resistance of approx. 8Ω/□ results with this voltage to achieve an optimum heating power. Advantageously a layer system is therefore deposited on a sealing disk with a sheet resistance R^{□} of 5 to 20Ω/□.

If the metal layer is to be used as a heating element, it is necessary to provide the metal layer with electric contacts. To this end, conductive contact elements, such as, for example, contact strips with electrical contact to the metal layer can be attached onto or under the metal layer. The contact strips are preferably arranged in edge areas and on opposite sides of the sealing disk. Modern designs of headlights entail that the outer shape of a sealing disk no longer has a simple rectangular structure. If it is assumed that the metal layer of a sealing disk is provided on the upper side and on the lower side with a contact strip, with today's headlights both contact strips would be spaced apart to a different degree in the course of the width of a headlight, which with a homogeneous thickness of the metal layer observed over the width of the headlight would result in a different electrical resistance between the contact strips and consequently in a different heating effect.

Regarding the layer thickness, with one embodiment the metal layer is therefore embodied inhomogeneously depending on the geometry of a sealing disk such that virtually constant resistance values are achieved between contact strips lying opposite.

Alternatively, the layer system can be divided on the surface of a sealing disk into segments, which can have any geometric shape, wherein each shape is separately contacted and is separately impinged with electrical parameters for heating. However, the prerequisite for this is that the layer system segments are embodied to be electrically insulated from one another. In this case, the layer system can also be embodied with constant thickness in the individual segments, and the electrical parameters with which a segment is impinged for heating, are adjusted according to the resistance value of the associated segment. If a homogeneous layer is to be formed, it is advantageous if the fluctuation range of the layer thickness is less than ±20%. If the layer system is subdivided into segments, however, the layer thicknesses can also vary from segment to segment.

The transmission in the visible light range and/or in the infrared range can likewise vary from segment to segment. This is advantageous, for example, when a sensor, such as, for example, an infrared sensor, is to be arranged behind a segment and requires specific transmission values. It can also be necessary hereby that no coating at all of a sealing disk is carried out in a segment area.

Since the optical impression is also increasingly important with a motor vehicle headlight, a contact strip that is located on the metal layer can be covered by an additional and decorative metal layer, which can be composed, for example, of steel or chromium.

To improve the adhesive properties of the layer system, furthermore an adhesive layer can be deposited between the sealing disk and the lower layer. An adhesive layer of this type can comprise an oxide of the elements Al, Ti or Cr, for example.

In a further embodiment, a cover layer, which can be, for example a plasma polymerization layer or a paint layer, is additionally located on the upper layer. A cover layer of this type can be embodied as a diffusion barrier layer, for example, in order to prevent corrosion, or it can be used to stabilize the layer system. Furthermore, a cover layer can have an additional reflection-reducing effect.

Another requirement for motor vehicle headlights exists with respect to the visual color impression made by the light of a headlight. In one embodiment the color locus of the light passing through the sealing disk therefore lies in the white range stipulated in ECE R112.

A method according to the invention for producing a headlight for a motor vehicle, with a sealing disk, which as a component of a housing seals an interior enclosed by the housing from the environment, is characterized in that a layer system, comprising a lower layer, followed by a metal layer and an upper layer, is deposited by means of a vacuum method on the side of the sealing disk directed towards the interior, wherein the lower layer and/or the upper layer is deposited either as a nitride of the elements Al or Si or as an oxide or a mixed oxide of the elements Si, Ti Al, Zn, Sn, In, Nb, Zr or Ta.

The oxide or the mixed oxide can thereby be doped with one or more of the elements Al, F, B, P, Ce, Sn, Zn or S and the metal layer comprising one or more of the elements Ag, Al, Cu, Au, Pd or Pt can be deposited.

In order to achieve a high transmission of the layer system, the upper layer and the lower layer should be deposited with a thickness of 20 nm to 70 nm and the metal layer should be deposited with a thickness of 5 nm to 20 nm.

CVD methods as well as PVD methods, like vapor deposition or sputtering, are suitable for depositing the layers of the layer system on the sealing disk. In the case of sputtering, in particular thin layers only a few nanometers thick with constant layer properties can be deposited. Coatings can also be realized with sputter methods in the event that a sealing disk is embodied in a very strongly concave manner to the interior. Thus, for example, a sputtering device without a magnetic field-producing device can be used, in which the target is adapted to the shape of the sealing disk.

Alternatively, a sputtering device with a magnetic-field producing device can be used and during the coating process the sputtering device either moved relative to the sealing disk surface to be coated or the sealing disk moved relative to the sputtering device, in order to provide all of the surface sections of the sealing disk with a homogeneous coating or also an intentionally inhomogeneous coating.

Another embodiment lies in coating the sealing disk by segment. This can be carried out, for example, in that a coating device is used and after the coating of a segment the sealing disk is repositioned and subsequently the next segment is coated. However, several coating devices can also be arranged such that several and optionally also all of the segments are coated simultaneously.

With the method according to the invention, an adhesive layer can be deposited between the sealing disk and the lower layer as well as a cover layer on the upper layer.

### EXEMPLARY EMBODIMENT

The invention is explained in more detail below based on a preferred exemplary embodiment. The Figs. show:

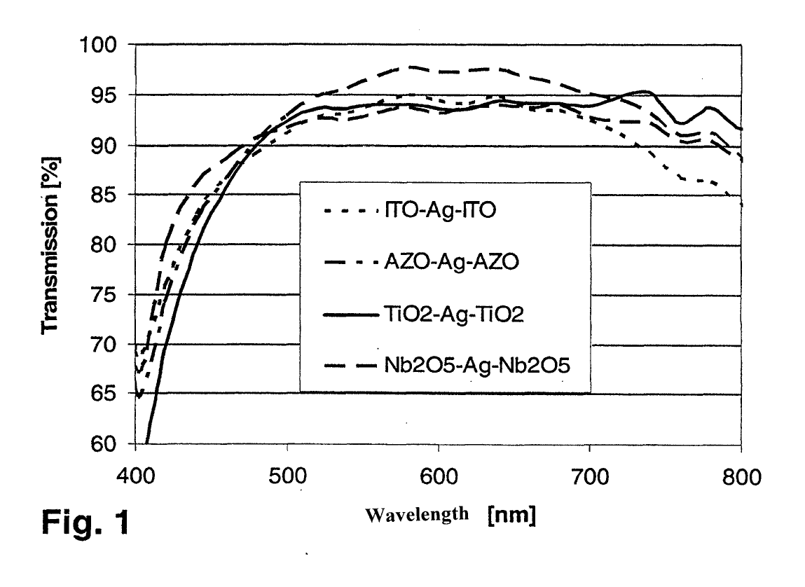

FIG. 1 A graphic representation of the transmission of different layer systems depending on the wavelength;

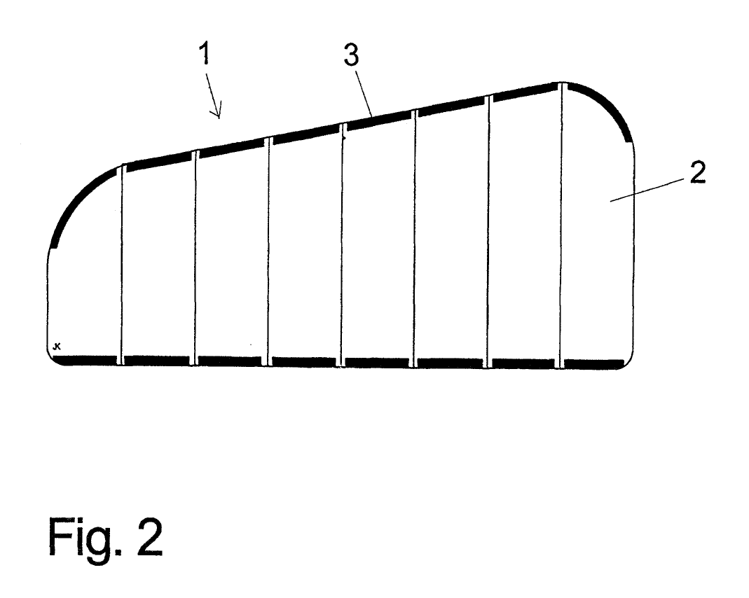

FIG. 2 A diagrammatic front view of the sealing disk of a motor vehicle front headlight according to the invention.

In test series four different layer systems were respectively deposited on a 4 mm thick plastic substrate of the material PC and tested with respect to their serviceability for motor vehicle headlights. Table 1 shows the layer materials with their layer thicknesses and a determined sheet resistance for the respective layer system.

TABLE 1

| | Lower layer | | Metal layer | | Upper layer | | Sheet |
|---|---|---|---|---|---|---|---|
| Ex- | | d in | | d in | | d in | resistance |
| ample | Material | nm | Material | nm | Material | nm | R^{□} in Ω/□ |
| 1 | ITO | 43 | Ag | 8.75 | ITO | 43 | 7.7 |
| 2 | AZO | 48 | Ag | 7.75 | AZO | 48 | 7.8 |
| 3 | TiO₂ | 38 | Ag | 9.25 | TiO₂ | 38 | 7.6 |
| 4 | Nb₂O₅ | 38 | Ag | 9.75 | Nb₂O₅ | 38 | 7.3 |

The abbreviations used thereby in Table 1 “ITO” stands for indium tin oxide and “AZO” stands for aluminum zinc oxide. All of the layers were deposited by means of magnetron sputterers, wherein a DC single magnetron was used for Ag and ITO layers and a double magnetron with a medium frequency of 25 kHz was used for AZO, TiO₂ and Nb₂O₅ layers.

It can be seen from Table 1 that a sheet resistance was measured for all four layer systems which is close to the optimum of approx. 8Ω/□, which is why the four layer systems guarantee very good heating powers.

In FIG. 1 the transparency of the four coated samples is plotted in relation to an uncoated PC substrate over a wavelength range. It can be seen from the curves shown that in the relevant wavelength range of 500 nm to 700 nm all four coated PC substrates have a transparency of at least 90% compared to an uncoated PC substrate, which conversely means that the four layer systems cause a reduction in transparency of less than 10%, which is why a sealing disk with one of these layer systems renders possible an excellent luminous effect.

A sealing disk 1 of a motor vehicle front headlight according to the invention is shown diagrammatically in front view in FIG. 2. On the side directed towards the interior of the headlight, a layer system according to example 1 from Table 1 with homogeneous layer thickness distribution has been deposited on the sealing disk 1. The layer system is thereby divided into elongated segments 2, wherein the individual segments 2 of the layer system are embodied to be electrically insulated from one another.

On the upper side and under side of the sealing disk 1, the Ag layer in each segment 2 is provided with a contact strip 3. The contact strips are thereby arranged in an edge area of the sealing disk 1, which edge area is covered in the installed state by other components of the associated headlight housing and/or of the motor vehicle bodywork.

An electric current is applied to each segment between the associated two contact strips 3, whereby a current flow occurs in particular through the Ag layer and thus heat is produced. Due to the different length of the segments 2 and the homogeneous layer thickness, the individual segments have a different electrical resistance between the contact strips 3. The contact strips of the individual segments are therefore impinged with different electrical parameters in order to produce a uniform heat development on the sealing disk surface.

Alternatively, the layer system in the segments 2 can also be deposited with different layer thickness such that the layer system in the segments 2 between the contact strips 3 has an at least almost identical electrical resistance value. The contact strips 3 of the individual segments 2 can then also be impinged with identical electrical parameters.

1. Headlight for a motor vehicle with a sealing disk, which as a component of a housing seals an interior enclosed by the housing from the environment, characterized in that a layer system, comprising a lower layer, followed by a metal layer and an upper layer, is deposited on the side of the sealing disk directed towards the interior, wherein the lower layer and/or the upper layer comprises
a) a nitride of the elements Al or Si
or
b) an oxide or a mixed oxide of the elements Si, Ti Al, Zn, Sn, In, Nb, Zr, or Ta.

2. Headlight according to claim 1, characterized in that the sealing disk is made of glass.

3. Headlight according to claim 1, characterized in that the sealing disk is made of a transparent plastic.

4. Headlight according to claim 1, characterized in that the oxide or mixed oxide of the lower layer and/or the upper layer is doped with one or more of the elements Al, F, B, P, Ce, Sn, Zn or S.

5. Headlight according to claim 1, characterized in that the lower layer and the upper layer have a thickness of 20 nm to 70 nm.

6. Headlight according to claim 1, characterized in that the metal layer is composed of one or more of the elements Ag, Al, Cu, Au, Pd or Pt.

7. Headlight according to claim 1, characterized in that the metal layer has a thickness of 5 nm to 20 nm.

8. Headlight according to claim 1, characterized in that the layer system has a sheet resistance R^{□} of 1 to 100Ω/□.

9. Headlight according to claim 1, characterized in that the transmission of the sealing disk in the wavelength range of 500 to 700 nm is reduced by the layer system by a maximum of 20%.

10. Headlight according to claim 1, characterized in that the layer system on the surface of the sealing disk is subdivided into segments.

11. Headlight according to claim 10, characterized in that the segments are embodied so as to be electrically insulated from one another.

12. Headlight according to claim 1, characterized in that at least one electrically conductive contact element with electrical contact to the metal layer is arranged in the edge area of the sealing disk above or below the metal layer.

13. Headlight according to claim 1, characterized in that a cover layer is applied on the upper layer.
